(19) United States
(12) Patent Application Publication
(10) Pub. No.: US 2011/0187193 A1
(43) Pub. Date: Aug. 4, 2011

(54) POWER DISTRIBUTION UNIT AND POWER MANAGEMENT ARCHITECTURE EMPLOYING THE SAME

(75) Inventors: Meng-Wen Pan, Taoyuan Hsien (TW); Chih-Chiang Chan, Taoyuan Hsien (TW)

(73) Assignee: DELTA ELECTRONICS, INC., Taoyuan Hsien (TW)

(21) Appl. No.: 13/081,885

(22) Filed: Apr. 7, 2011

(30) Foreign Application Priority Data
Jan. 4, 2001 (TW) 100100243

(51) Int. Cl. H02J 3/14

(52) U.S. Cl. 307/39

(57) ABSTRACT

Disclosed is a power distribution unit and power management architecture employing such power distribution unit. The power management architecture includes a remote power management system for managing a plurality of power appliances, and a plurality of power distribution units each of which is provided with wireless network connectivity. With the wireless network connectivity, the remote power management system and the power distribution units constitute a mesh link network for two-way data transmission. In operation, the remote power management system transmits a first profile to the power distribution units to allow the first control unit of the power distribution unit to real-timely control the operation of the power distribution units according to the management policy and/or the management principle recorded in the first profile.

### FIELD OF THE INVENTION

The present invention is related to a power distribution unit and power management architecture, and more particularly to a power distribution unit and a power management architecture employing the same.

### BACKGROUND OF THE INVENTION

With the progress of computer technology and the rapid growth of Internet, the service or utility rendered by the Internet is mushrooming. Therefore, the number of the data center which is consisted of a plurality of computers or servers is increasing. In order to allow the data center to provide more services or utilities over the Internet, the number of the computer or server of the data center has to be increased. As a result, the problems arising from the power supply and the power distribution as well as the power management of the data center is forthcoming. In order to meet the demands of power supply, distribution and management for the data center, the data center uses power distribution units to distribute the required power for each computer or server. Furthermore, a remote power management system 11 is employed to manage each power distribution unit to check whether each power distribution unit supplies the required power for the computers or servers, thereby optimizing the power efficiency for the data center.

Referring to FIG. 1, in which the systematic architecture of a conventional power management architecture is shown. As shown in FIG. 1, the control mechanism and connection topology of the conventional power management architecture 1 is hierarchical. Power distribution units 12a-12f are hierarchically connected to the remote power management system 11, so that the remote power management system 11 manages the operation of the computers or servers connected to each power distribution unit. Here, the Ethernet hub 13a of the root layer is connected to the remote power management system 11. The first power distribution unit 12a, the second power distribution unit 12b, the third power distribution unit 12c, and the second Ethernet hub 13b of the first layer are connected to the first Ethernet hub 13a of the root layer. The fourth power distribution unit 12d, the fifth power distribution unit 12e, and the sixth power distribution unit 12f are connected to the second Ethernet hub 13b of the first layer. Therefore, the data of the first power distribution unit 12a, the second power distribution unit 12b, and the third power distribution unit 12c mounted on the cabinet 15a are required to be transmitted to the remote power management system 11 through the first Ethernet hub 13a. Likewise, the data of the fourth power distribution unit 12d, the fifth power distribution unit 12e, and the sixth power distribution unit 12f mounted on the second cabinet 15b are required to be transmitted to the remote power management system 11 through the first Ethernet hub 13a and the second Ethernet hub 13b.

Overall speaking, the data transmission and connection relationship of the power distribution units 12a-12f and the remote power management system 11 are hierarchical. In operation, the power distribution units 12a-12f are configured to periodically detect the status information. The status information may be the output power of each power outlet of the power distribution unit, or the operative circumstances indicating the power outlets of which are currently supplying power and the power outlets of which are not currently supplying power. These status information are real-timely transmitted to the remote power management system 11 at the top layer, so that the remote power management system 11 can periodically receive the real-time status information of each power distribution unit for controlling the operation of the power distribution units. Therefore, the remote power management system 11 may accurately and promptly manage the power usage for the power management architecture.

As each power distribution unit needs to frequently transmit vast real-time status information to the remote power management system 11 and frequently receive control instructions from the remote power management system 11, the digital data transmission quantity over the network is huge and the digital data transmission efficiency over the network is low. Hence, it is required to optimize the control program of the remote power management system 11. For example, the priority for controlling the power distribution units and the priority for receiving the information and transmitting the instruction have to be optimized to prohibit a prolonged transmission time for transmitting the information and instruction or prohibit a prolonged reaction time for the remote power management system 11. In this manner, the problem that the power distribution units can not operate normally as a result of a prolonged transmission time or a prolonged reaction time can be addressed. In order to allow the remote power management system 11 to process vast real-time status information and control each power distribution unit according to the vast real-time status information, the remote power management system 11 needs a processor, a RAM, and a high disk drive with faster processing speed, higher sale price, and more power consumption.

Nonetheless, the optimization process has to take the hierarchical relationship of each power distribution unit, the transmission efficiency over the network, and the operating characteristics of the power appliances connected to the power distribution units into consideration. For example, the mainstay server requires a higher priority, shorter reaction time, and more processing routines in order to optimize the priority for controlling the power distribution units, the reception of the information, and the transmission of the instructions. Thus, the optimization process is complicated and hard to achieve.

In order to attain the hierarchical data transmission and hierarchical connection relationship, the first cabinet 15a and the second cabinet 15b are placed in neighborhood. This would render the placement of the cabinets inflexible and impose constraints on the network cable layout. Hence, the designer has to pre-design the layout of the data center. However, the network environment is ever-changing and the number of the computers or servers in the data center has to be properly adapted depending on the current network environment. As the conventional power management architecture 1 is required to add new computers or servers or remove operating computers or servers, the designer has to redesign the connection relationship of the power appliances and change the network cable layout and relocate the servers. Furthermore, the control program of the remote power management system 11 has to be optimized. This would complicate the re-design process and increase the cost.

Hence, the invention proposes a power distribution unit and a power management architecture employing such power distribution unit to address the aforementioned problems encountered by the prior art.

### SUMMARY OF THE INVENTION

An object of the invention is to provide power distribution units and a power management system employing the same, in which the power distribution units are interconnected in an non-hierarchical manner to constitute a mesh link network by wireless network connectivity. In this way, the cabinet which houses the digital data processing devices and power distribution units may be relocated arbitrarily without being limited by the constraint of the network cable layout. The designer may increase or decrease the number of he power distribution units without inflicting the complexity of the adaptation of the network cable layout or increasing the cost. Each power distribution unit and/or each local power management unit control the operation of the power distribution unit real-timely according to the management policy and/or management principle recorded in the respective profile, thereby attaining the operation mode of localized management for power distribution units. Therefore, the remote power management system may use processors, memories, or hard disk drives with slower processing speed, lower sale price, and lower power consumption, thereby simplifying the optimization process and easing the optimization process.

Besides, each power distribution unit and local power management unit records or processes the detected status information and then transmits the processed status information to the remote power management system, thereby diminishing the digital data transmission quantity over the mesh link network and enhancing the data transmission efficiency. The remote power management system may group the power distribution units and/or the local power management units that are connected to digital data processing devices having similar operating characteristics as a large virtual power distribution unit. Moreover, the power distribution units and/or the local power management units of the same group may transmit the status information of the power appliances in a peer-to-peer mode, thereby allowing the digital data processing devices having similar operating characteristics to have better operating characteristics.

To this end, the invention provides a power management architecture including: a remote power management system for managing a plurality of power appliances, and a plurality of power distribution units each of which is provided with wireless network connectivity for allowing the remote power management system and the power distribution units to constitute a mesh network link for two-way data transmission. In operation, the remote power management system transmit a respective first profile to the power distribution units for allowing the first control unit of each power distribution unit to real-timely control the operation of the power distribution unit according to the management policy and management principle recorded in the first profile.

To this end, the invention provides a power distribution unit for connecting to a plurality of power appliances. The power distribution unit includes a first control unit for controlling the operation of the power distribution unit; a wireless communication unit connected to the first control unit; a first memory connected to the first control unit; a first storage unit connected to the first control unit for storing a first profile and a first operation program; a plurality of power outlets; and a power management unit connected to the power outlets and the first control unit for selectively supplying the input voltage provided by a power supply to the power outlets and detecting the status information of the connected power appliance. As the power distribution unit is operating, the first control unit executes the first operation program and real-timely controls the operation of the power management unit according to the management policy or management principle recorded in the first profile, thereby constituting a mesh network link with the remote power management system and other power distribution units by its wireless network connectivity for two-way data transmission.

Now the foregoing and other features and advantages of the present invention will be best understood through the following descriptions with reference to the accompanying drawings, wherein:

### BRIEF DESCRIPTION OF THE DRAWINGS

FIG. 1 shows the systematic architecture of a conventional power management architecture;

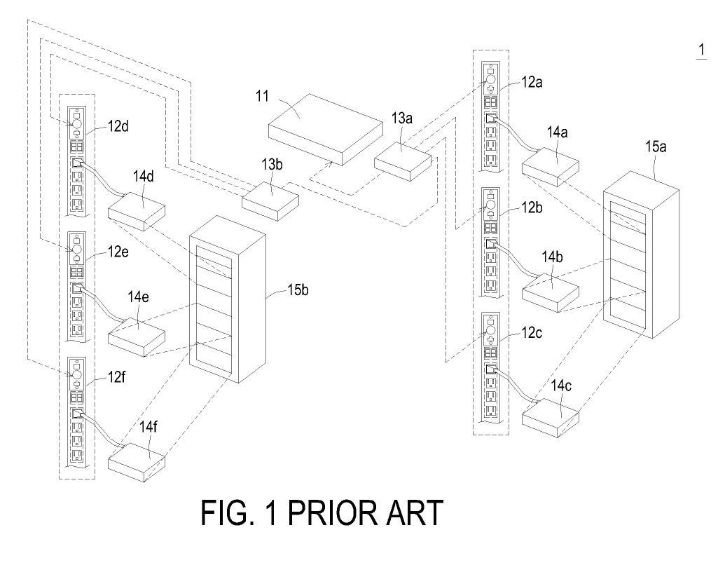

FIG. 2 is a plan view showing the power management architecture according to an exemplary embodiment of the invention;

FIG. 3 is a circuit block diagram showing the power distribution unit according to an exemplary embodiment of the invention;

FIG. 4 is a plan view showing the power management architecture according to another exemplary embodiment of the invention; and

FIG. 5 is a circuit block diagram showing the local power management unit according to the exemplary embodiment of the invention.

### DESCRIPTION OF THE PREFERRED EMBODIMENT

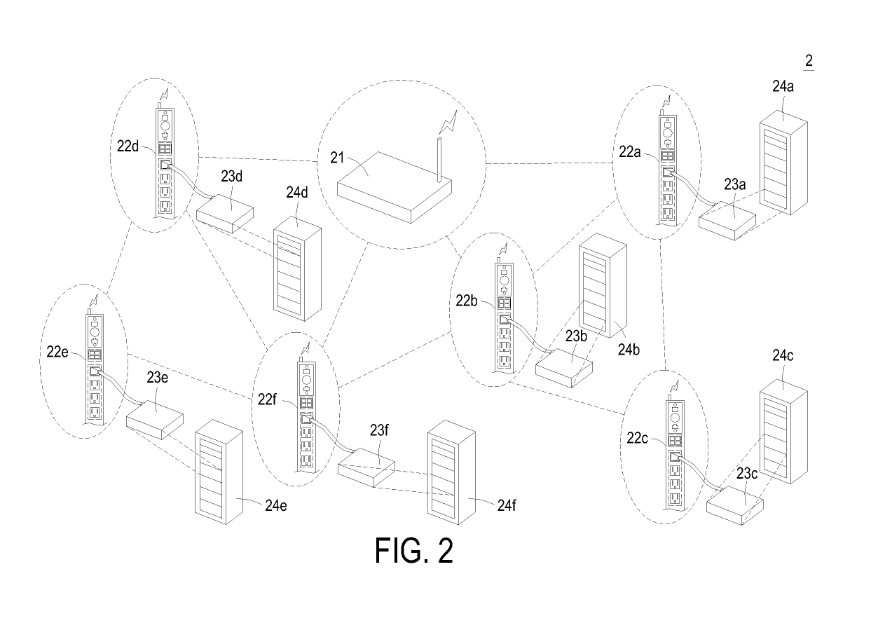

FIG. 2 is a plan view showing the power management architecture according to an exemplary embodiment of the invention. The power management architecture 2 includes a remote power management system 21 and power distribution units 22a-22f, in which each power distribution unit and the remote power management system 21 are provided with wireless network connectivity for allowing the power distribution units 22a-22f and the remote power management system 21 constitute a mesh link network for two-way data transmission according to the requirements of operation and spatial distance between the power distribution unit and the remote power management system 21.

In the present embodiment, the remote power management system 21 is connected to the first power distribution unit 22a, the second power distribution unit 22b, the fourth power distribution unit 22d, and the sixth power distribution unit 22f by its wireless network connectivity, such that the remote power management system 21 is able to manage the digital data processing device sets 23a-23f (for example, computers or servers), each of which are respectively connected to a power distribution unit. The connection relationship among the power distribution units 22a-22f may be established as follows:

(1) 22a: 21, 22b, 22c;

(2) 22b: 21, 22a, 22c, 22f;

(3) 22c: 22a, 22b;

(4) 22d: 21, 22e, 22f;

(5) 22e: 22d, 22f;

(6) 22f: 21, 22b, 22d, 22e;

It can be understood from the above descriptions that the first power distribution unit 22a is connected to the remote power management system 21, the second power distribution unit 22b, and the third power distribution unit 22c by its wireless network connectivity. The third power distribution unit 22c is connected to the first power distribution unit 22a and the second power distribution unit 22b by its wireless network connectivity. Although the third power distribution unit 22c is not directly connected to the remote power management system 21, the third power distribution unit 22c is able to transmit data with the remote power management system 21 through the second power distribution unit 22b.

The remote power management system 21 and the power distribution units 22a-22f are not interconnected hierarchically, but are wirelessly interconnected as a mesh link network. Therefore, the cabinets 24a-24f that are used to place the digital data processing device sets 23a-23f and the power distribution units 22a-22f do not need to be placed closely with each other as a result of the constraints of network cable layout. Hence, the designer of the data center will not be annoyed by the network cable layout.

Also, as the remote power management system 21 and the power distribution units 22a-22f of the power management architecture 2 have different operating modes, the remote power management system 21 will transmit the respective first profile to the power distribution units 22a-22f to allow the first control unit (not shown) of each power distribution unit to real-timely control the operation of the power distribution unit according to the management policy and/or management principle recorded in the first profile. Each power distribution unit is configured to record and process the detected status information according to the management policy and/or management principle recorded in the first profile which is obtained from the remote power management system 21, and thus the processed status information is transmitted to the remote power management system 21. Therefore, the inventive remote power management system 21 does not need to real-timely receive the detected real-time status information of the power distribution units 22a-22f, and does not need to real-timely control the operation of the power distribution units 22a-22f according to the real-time status information of the power distribution units 22a-22f. That is, the remote power management system 21 does not need to receive the status information from each power distribution frequently or transmit instructions to each power distribution frequently.

For example, the first control unit (not shown) of the first power distribution unit 22a is able to control whether the power outlet of the first power distribution unit 22a is allowed to real-timely supply power to the connected first digital data processing device 23a according to the management policy and/or management principle recorded in the first profile which is obtained from the remote power management system 21. In the present embodiment, as the first profile indicates that the recorded hours for power supply is 06:00-22:00, the first control unit (not shown) of the first power distribution unit 22a will supply power from the power outlet spontaneously to the first digital data processing device 23a to enable the first digital data processing device 23a during 06:00-22:00, and cease the power supply for the first digital data processing device 23a to disable the first digital data processing device 23a during 22:00-06:00. However, the conventional power management architecture requires the management system to real-timely transmit the instructions to the conventional power distribution units during 06:00-22:00 to control the power supply from the power outlet of the conventional power distribution unit to the connected digital data processing device. Afterwards, the conventional management system is managed to real-timely transmit instructions to the conventional power distribution units to cease the power supply from the power outlet of the conventional power distribution unit to the connected digital data processing device, thereby disabling the digital data processing device. Hence, the operation of the inventive power management architecture 2 is obviously different the operation of the conventional power management architecture.

Alternatively, the first power distribution unit 22a is configured to detect the status information. The status information may denote the output power of each power outlet, or the operative circumstances indicating the power outlets of which are currently supplying power and the power outlets of which are not currently supplying power. Unlike the conventional power management architecture, the first power distribution unit 22a is configured to record or process the detected status information according to the management policy and/or management principle recorded in the first profile, and transmits the processed status information to the remote power management system 21. In the present embodiment, the power distribution unit 22a is configured to periodically detect the output power and output current of each power outlet, and store the detected information in a first storage unit or a first memory (not shown) of the first power distribution unit 22a. The period for detecting the power outlet would be 1 millisecond. The stored information in connection with the output power and output current of each power outlet that are recorded at different time may be used to calculate the average output power and average output current of each power outlet. Or otherwise, the stored information in connection with the output power and output current of each power outlet that are recorded at different time may be used to draw a historical diagram of average output power versus time or draw a historical diagram of average output current versus time. Afterwards, when the remote power management system 21 sends a transmission request to the first power distribution unit 22a for data transmission or when the response time (e.g. 10 minutes) is reached, the first power distribution unit 22a is configured to compress the recorded status information in connection with the output power or output current into a status information compressed file for transmission to the remote power management system 21, thereby diminishing the data transmission quantity.

In alternative embodiments, the power distribution units 22a-22f may transmit the status information compressed file, the average output power, the average output current, the historical diagram of average output power versus time, and the historical diagram of average output current versus time to the remote power management system 21 periodically when the response time is reached. The each power distribution unit will not transmit the real-time status information to the remote power management system 21 periodically when the detection time is reached, and the remote power management system 21 will not transmit instructions to the power distribution units 22a-22f according to the respective status information of the power distribution units 22a-22f periodically when the detection time is reached. Thus, the network will not be burdened frequently with vast real-time information transmission and control instructions. According to the invention, the status information is recorded and stored, and transmitted to the remote power management system 21 until the status information has been accumulated to a large quantity. Hence, the power management architecture 2

Furthermore, as the remote power management system 21 is operating, the data quantity over the mesh network link is small. Moreover, each power distribution unit is connected to other power distribution units in a meshed network instead of a hierarchical topology. More advantageously, the remote power management system 21 does not need to receive the real-time status information detected by the power distribution units 22a-22f (i.e. periodically when the detection time is reached). Moreover, the remote power management system 21 does not need to transmit instructions to each power distribution unit to control the operation of each power distribution unit according to the status information real-timely received from the each power distribution unit (i.e. periodically when the detection time is reached). Hence, the optimization process does not need to consider the hierarchical relationship of each power distribution unit, the digital data transmission efficiency over the network, and the operating characteristics of the power appliances connected to the power distribution units. Therefore, the optimization process is simple and easy to attain. The remote power management system 21 may be implemented by processors, memories, and hard disk drives with slow processing speed, low sale price, and low power consumption.

In the present embodiment, the operating characteristics of the digital data processing devices 23a-23c connected to the power distribution units 22a-22c are alike. In this case, the digital data processing devices 23a-23c may be web servers connected in parallel for operation. In order to allow the digital data processing devices 23a-23c having similar operating characteristics to have better operating characteristics, the remote power management system 21 groups the power distribution units 22a-22c as a first group and virtualizes the power distribution units 22a-22c in the first group as a bulky first virtual power distribution unit, and the management policy and/or the management principle recorded in the first profile of the first group has to consider the operating characteristics of the power appliances connected to the first group. Likewise, the digital data processing devices 23d-23f which are connected to the power distribution units 22d-22f have similar operating characteristics, and thus the remote power management system 21 groups the power distribution units 22d-22f as a second group. The power distribution units 22d-22f in the second group are virtualized as a bulky second virtual power distribution unit, and the management policy and/or the management principle recorded in the first profile of the second group has to consider the operating characteristics of the power appliances connected to the second group.

In the present embodiment, the power distribution units 22a-22f are configured to transmit the status information of the connected power appliances with each other in a peer-to-peer manner. The status information may be the output power of each power outlet of the power distribution unit, or the operative circumstances indicating the power outlets of which are currently supplying power and the power outlets of which are not currently supplying power. When the first group or the second group is operating, the power distribution units in the same group will transmit the status information of the connected power appliances with each other in a peer-to-peer manner, so that the first control unit (not shown) of each power distribution unit in the same group may real-timely control the operation of the power distribution unit according to the status information of the power distribution unit in the same group and the management policy and/or the management principle recorded in the first profile. Also, each power distribution unit in the same group may record or process the detected status information according to the management policy and/or the management principle recorded in the first profile, and then transmits the processed status information to the remote power management system 21.

For example, when the first control unit (not shown) of the power distribution unit 22a in the first group is operating, the status information of the first digital data processing device 23a connected to the first power distribution unit 22a will be taken into consideration. Moreover, the status information of the second digital data processing device 23b connected to the second power distribution unit 22b and the status information of the third digital data processing device 23c connected to the third power distribution unit 22c will also be taken into consideration. The operation of the first power distribution unit 22a will be controlled according to the status information of the first group and the management policy and/or the management principle recorded in the first profile. The first power distribution unit 22a will record or process the detected status information according to the management policy and/or the management principle recorded in the first profile, and then transmit the processed status information to the remote power management system 21.

In the present embodiment, when the user adjusts or change the appliances in the data center to increase or decrease the number of the power distribution units in the first group or the second group, the remote power management system 21 will dynamically update the first profile of each power distribution unit to regroup the first group or the second group, thereby increasing or decreasing the number of the power distribution unit in the first group or the second group. Therefore, the remote power management system 21 may increase or decrease the number of the power distribution unit in each group with ease.

For example, when the user adjusts or change the appliances in the data center to allow the operating characteristics of the third digital data processing device 23c connected to the third power distribution unit 22c to be different from the operating characteristics of the digital data processing devices 23a-23b connected to the power distribution units 22a-22b, the remote power management system 21 removes the third power distribution unit 22c from the first group by dynamically updating the first profile of the power distribution units 22a-22b and regrouping the first group accordingly.

In alternative embodiments, when the power distribution units 22a-22f is powered on, the environment appliances will be found out by the mesh network link and the environmental information of the environment appliances will be obtained. The environmental information of the environment appliances may be the temperature of the data center or the operating condition of the air conditioners. In this way, the power distribution units 22a-22f can consider the environmental information and adjust the operating conditions of the power distribution units 22a-224 accordingly.

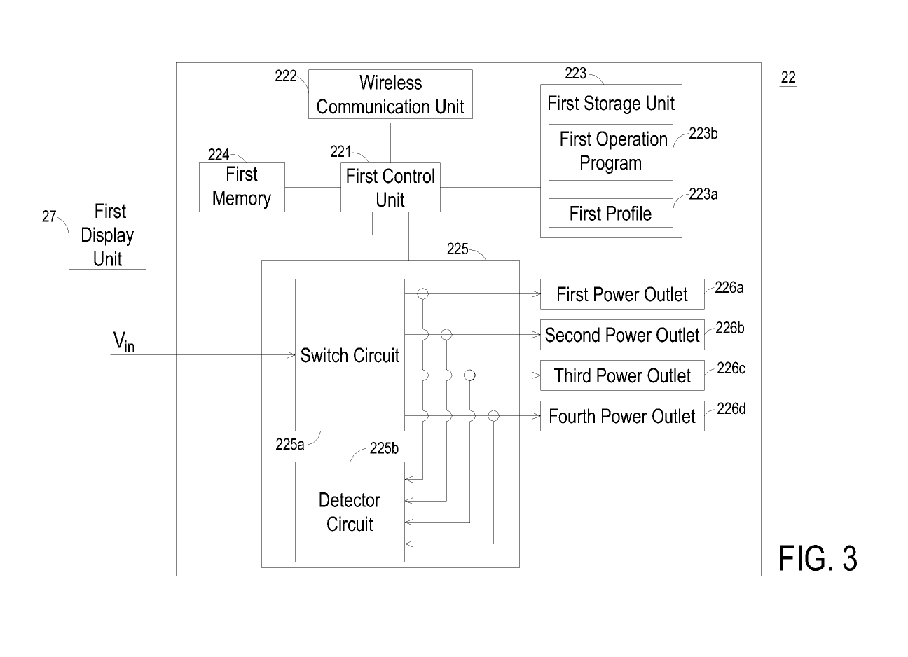

Referring to FIG. 2 and FIG. 3, in which FIG. 3 is a circuit block diagram showing the power distribution unit according to an exemplary embodiment of the invention. As shown in FIG. 3, the smart power distribution unit 22 of the invention includes a first control unit 221, a wireless communication unit 222, a first storage unit 223, a first memory (RAM) 224, a power management unit 225, and power outlets 226a-226d. The first control unit 221 is respectively connected to the wireless communication unit 222, the first storage unit 223, the first memory 224, and the power management unit 225 for controlling the operation of the power distribution unit 22.

The wireless communication unit 222 may be compliant with the IEEE 802.11a-n protocol, the Wi-Fi protocol, the Bluetooth protocol, or the ZigBee protocol for allowing the first control unit 221 to transmit data wirelessly by the wireless communication unit 222. The first storage unit 223 is a volatile memory, e.g. a flash memory, an EPROM, an EEPROM, or a hard disk drive. The first storage unit 223 is used to store a first profile 223a and a first operation program 223b. When the power distribution units 22 are operating, the first control unit 221 executes the first operation program 223b and real-timely controls the operation of the power management unit 225 according to the management policy and/or the management principle recorded in the first profile 223a. The remote power management system 21 is configured to dynamically update the first profile 223a in the first storage unit 223. The first memory 224 may be a DDR SDRAM for providing the program and data which are temporarily stored during the operation of the first control unit 221. The program and data which are stored in the first memory 224 may be the first operation memory 223b and the first profile 223a.

In the present embodiment, the power management unit 225 includes a switch circuit 225a and a detector circuit 225b for selectively outputting the input voltage Vin provided by a power supply (not shown) to power outlets 226a-226d for enabling the connected digital data processing device and detecting the status information of the connected digital data processing device. The switch circuit 225a may be a relay, a MOSFET, a silicon-controlled rectifier (SCR), a TRIAC, or an isolated gate bipolar transistor (IGBT). In operation, the first control unit 221 controls the operation of the switch circuit 225a to allow the input voltage Vin to be selectively transmitted to the power outlets 226a-226d through the switch circuit 225a. The detector circuit 225b is connected to the switch circuit 225a and the power outlets 226a-226d for detecting the status information of the digital data processing devices connected to the power outlets 226a-226d and transmitting the detected status information to the first control unit 221. Afterwards, the first control unit 221 will record the status information in the first storage unit 223 and process the status information and transmit the processed status information to the power management unit 21.

In the present embodiment, the power distribution units 22 further includes a first display unit 27 which is connected to the first control unit 221 for displaying the operating information of the power distribution units 22. The first display unit 27 may be mounted inside the power distribution units 22 or outside of the power distribution units 22, and may be implemented by LEDs or LCD panels.

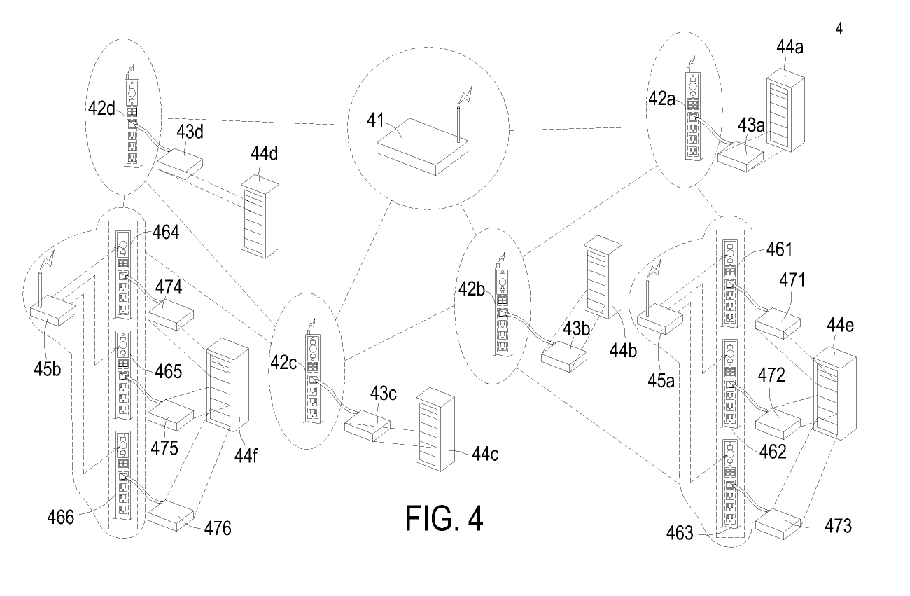

Referring to FIG. 4 and FIG. 2, in which FIG. 4 is a plan view showing the power management architecture according to another exemplary embodiment of the invention. The difference between FIG. 4 and FIG. 2 is that the power management architecture 4 of FIG. 4 includes local power management unit 45a, 45b in addition to the remote power management system 41 and power distribution units 42a-42d. Likewise, the power distribution units 42a-42d, the local power management units 45a-45b, and the remote power management system 41 are all provided with wireless network connectivity. The power distribution units 42a-42d, the local power management units 45a-45b, and the remote power management system 41 constitute a mesh network link for two-way data transmission by the wireless network connectivity.

In the present embodiment, the digital data processing devices 43a-43d and the power distribution units 42a-42d are respectively placed in the cabinets 44a-44d. The first local power management unit 45a, the power distribution units 461-463 in the first sector, and the digital data processing devices 471-473 are placed in the fifth cabinet 44e. The second local power management unit 45b, the power distribution units 464-466 in the second sector, and the digital data processing devices 474-476 are placed in the sixth cabinet 44f. The connection relationship of the mesh network link consisted of the power distribution units 42a-42d and the local power management units 45a-45b may be established as follows:

(1) 42a: 41, 42b, 45a;

(2) 42b: 41, 42a, 42c, 45a;

(3) 42c: 41, 42b, 42d, 45b;

(4) 42d: 41, 42c, 45b;

(5) 45a: 42a, 42b;

(6) 45b: 42c, 42d

In the present embodiment, the power distribution units 461-463 in the first sector may be traditional power distribution units without wireless network connectivity and may be connected to the internal communication interface of the first local power management unit 45a by a wired communication interface. The wired communication interface for connecting the power distribution units 461-463 and the first local power management unit 45a may be a serial communication interface (RS-232, RD-499, RS-423, RS-485) promulgated by Electronic Industries Alliance (EIA), a controller area network (CAN-bus) interface, a FireWire interface (IEEE 1394 interface), a Bluetooth interface, a Fibre Channel interface, an infiniband interface, or an Ethernet interface.

In the present embodiment, the remote power management system 41 transmits the first profile to the power distribution units 42a-42d. In addition, the emote power management system 41 also transmits the second profile to the local power management units 45a-45b. Thus, the second control unit (not shown) of the first local power management unit 45a or the second control unit (not shown) of the second local power management unit 45b real-timely control the operation of the power distribution units 461-463 (464-466) connected through the internal communication interface according to the management policy and/or the management principle recorded in the respective second profile. Besides, the second control units of the local power management units 45a-45b are configured to record or process the detected status information provided by the power distribution units 461-463 (464-466) according to the management policy and/or the management principle recorded in the second profile which are obtained by the remote power management system 41. Afterwards, the processed status information is transmitted to the remote power management system 41.

In other words, the power management architecture 4 may control the operation of the conventional power distribution units 461-463 (464-466) by the first local power management unit 45a and the second local power management unit 45b. Also, the first local power management unit 45a and the second local power management unit 45b may exchange the status information of the power appliances connected to other power distribution units in a peer-to-peer manner. The status information may be the status information of the power distribution unit, the power supply unit, the battery pack, the sensors, and the human management interface.

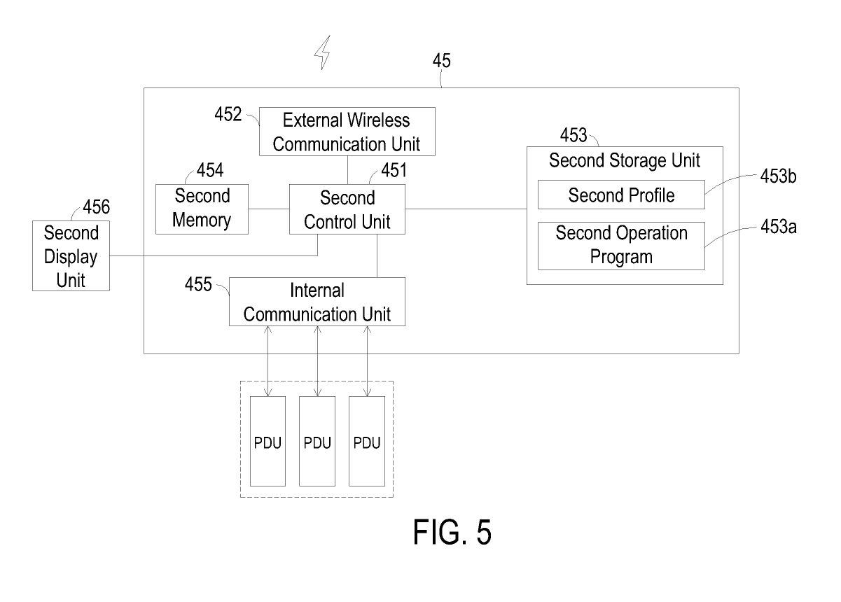

Referring to FIG. 5 and FIG. 4, in which FIG. 5 is a circuit block diagram showing the local power management unit according to the exemplary embodiment of the invention. As shown in FIG. 5, the local power management unit 45 includes a second control unit 451, an external wireless communication unit 452, a second storage unit 453, a second memory 454, and an internal communication interface 455. The second control unit 451 is connected to the external wireless communication unit 452, the second storage unit 453, the second memory 454, and the internal communication interface 455 for controlling the operation of the local power management unit 45.

The external wireless communication unit 452 may be compliant with the IEEE 802.11a-n protocol, the Wi-Fi protocol, the Bluetooth protocol, or the ZigBee protocol. The external wireless communication unit 452 is used for allowing the first control unit 221 to transmit data wirelessly through the wireless communication unit 222. The first storage unit 223 is a non-volatile memory for storing a second profile 453a and a second operation program 453b. As the local power management unit 45 is operating, the second control unit 451 may execute the second operation program 453b and real-timely control the operation of power distribution units connected to the internal communication interface 455 according to the management policy and/or management principle recorded in the second profile 453a. The remote power management system 41 may control the operation of the power distribution units connected to the local power management unit 45 by dynamically refreshing the second profile 453a in the second storage unit 453. The second memory 454 may be a DDR SDRAM for providing the program and data which are temporarily stored during the operation of the second control unit 451. The stored program and data in the second memory 454 may be the second operation program 453b and the second profile 453a.

In the present embodiment, the local power management unit 45 further includes a second display unit 456 connected to the second control unit 451 for displaying the operation information of the power distribution units connected to the internal communication interface 455 of the local power management unit 45. The second display unit 456 may be mounted inside the local power management unit 45 or outside of the local power management unit 45. Also, the second display unit 456 may be implemented by LEDs or LCD panels.

In conclusion, the remote power management system, the power distribution units, and the local power management units in the inventive power management architecture are not interconnected in a hierarchical manner but are interconnected wirelessly to constitute a mesh network link. Thus, the placement of the cabinet housing the digital data processing devices and power distribution units is not limited by the constraints of the network cable layout but is flexible for movement. When the data center needs to increase or decrease the number of the computers or servers in the data center depending on the current network environment, the designer may to increase or decrease the number of the computers or servers without difficulty or cost elevation.

Also, the inventive remote power management system does not need to real-timely receive the status information of each power distribution unit and control the operation of the power distribution units and the local power management units accordingly. Each power management unit and local power management unit may real-timely control the operation of the power distribution units according to the management policy and/or management principle recorded in the first profile, thereby attaining the operation mode of localized management for power distribution units. Therefore, the remote power management system may use processors, memories, or hard disk drives with slow processing speed, low sale price, and low power consumption.

Furthermore, each power distribution unit and local power management unit will not transmit the detected status information to the remote power management system periodically. Instead, the detected status information is recorded or processed and then the processed status information is transmitted to the remote power management system. Therefore, the network will not be burdened by transmitting vast real-time status information and control instructions. Thus, the data transmission quantity over the mesh network link is diminished and the transmission efficiency is improved. Moreover, in order to allow the digital data processing devices having similar operating characteristics to have better operating characteristics, the remote power management system may group the power distribution units and/or the local power management units connected to digital data processing devices having similar operating characteristics as a large virtual power distribution unit. The power distribution units and/or local power management units in the same group may transmit status information of the power appliances with each other in a peer-to-peer manner.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A power management architecture, comprising:
a remote power management system for managing a plurality of power appliances;
a plurality of power distribution units, each of which is provided with a wireless communication unit having wireless network connectivity for allowing the remote power management system and the power distribution units to constitute a mesh link network for two-way data transmission;
wherein the remote power management system is configured to transmit a respective first profile to the power distribution units to allow a first control unit of each power distribution unit to real-timely control operation of the power distribution units according to a management policy and/or a management principle recorded in the first profile.

2. The power management architecture according to claim 1 wherein the power distribution units are configured to detect status information of the power appliances connected therewith and record or process detected status information according to the management policy and/or the management principle, and transmit processed status information to the remote power management system.

3. The power management architecture according to claim 2 wherein the power distribution units are configured to periodically detect the status information of the power appliances by a detection time, and when the remote power management system requests the power distribution units to transmit the status information, the power distribution units compress the status information into a status information compressed file for allowing the power distribution units to transmit the status information compressed file and/or the status information to the remote power management system.

4. The power management architecture according to claim 2 wherein the status information represents an output power and an output current of the power appliances, and the power distribution units calculate an average output power and an average output current by the output power and the output current represented in the status information or draw a historical diagram of the output power versus time and draw a historical diagram of the output current versus time by the output power and the output current represented in the status information.

5. The power management architecture according to claim 2 wherein the remote power management system is configured to selectively group power distribution units connected to power appliances having similar operating characteristics as a large virtual power distribution unit.

6. The power management architecture according to claim 5 wherein the remote power management system regroups the power distribution units by dynamically updating the first profile of each power distribution unit, thereby increasing or decreasing the number of the power distribution unit in each group.

7. The power management architecture according to claim 2 wherein the power distribution units in the same group are configured to transmit status information of the power appliances with each other in a peer-to-peer manner.

8. The power management architecture according to claim 1 wherein the power appliances is a digital data processing device and the wireless communication unit is compliant with IEEE 80211a-n protocol, Wi-Fi protocol, Bluetooth protocol, or ZigBee protocol.

9. The power management architecture according to claim 1 wherein the power distribution unit includes:
the first control unit for controlling operation of the power distribution unit;
the wireless communication unit connected to the first control unit;
a first memory connected to the first control unit;
a first storage unit connected to the first control unit for storing a first profile and a first operation program;
a plurality of power outlets; and
a power management unit connected to the power outlets and the first control unit for selectively outputting an input voltage provided by a power supply to the power outlets and detecting status information of power appliances connected therewith;
wherein the first control unit is configured to execute the first operation program and real-timely control operation of the power management unit according to a management policy and/or a management principle recorded in the first profile.

10. The power management architecture according to claim 1 further comprising:
a first local power management unit having wireless network connectivity for constituting a mesh network link with the power distribution units and the remote power management system for two-way data transmission; and
a plurality of power distribution units in a first sector connected to an internal communication interface of the first local power management unit;
wherein the remote power management system transmits the first profile and a second profile to the power distribution units and the first local power management units to allow a second control unit of the first local power management unit to control operation of the power distribution unit in the first sector according to a management policy and/or a management principle recorded in the second profile.

11. The power management architecture according to claim 10 wherein the first local power management unit includes:
the second control unit for controlling operation of the first local power management unit;
an external wireless communication unit connected to the second control unit;
a second storage unit connected to the second control unit for storing the second profile and a second operation program; and
the internal communication interface connected to the second control unit and the power distribution units in the first sector;
wherein when the first local power management unit is operating, the second control unit executes the second operation program and controls operation of the power distribution units in the first sector according to the management policy and/or the management principle recorded in the second profile.

12. The power management architecture according to claim 11 wherein the first local power management unit further includes:
a second display unit connected to the second control unit and mounted inside the first local power management unit or outside of the first local power management unit for displaying operating information of the power distribution units connected to the internal communication interface.

13. A power distribution unit, comprising:
a first control unit for controlling operation of the power distribution unit;
a wireless communication unit connected to the first control unit;
a first memory connected to the first control unit;
a first storage unit connected to the first control unit for storing a first profile and a first operation program;
a plurality of power outlets; and
a power management unit connected to the power outlets and the first control unit for selectively outputting an input voltage provided by a power supply to the power outlets and detecting status information of power appliances connected therewith;
wherein the first control unit is configured to execute the first operation program and real-timely control operation of the power management unit according to a management policy and/or a management principle recorded in the first profile, and constitute a mesh network link with a remote power management system and other power distribution units for two-way data transmission.

14. The power distribution unit according to claim 13 further comprising a first display unit connected to the first control unit for displaying operating information of the power distribution unit, and wherein the first display unit is mounted inside the power distribution unit or mounted outside of the power distribution unit.

15. The power distribution unit according to claim 13 wherein the first control unit is configured to detect status information of the power appliances by the power management unit and record or process the status information according to the management policy and/or the management principle recorded in the first profile, and transmit processed status information to the remote power management system.

16. The power distribution unit according to claim 13 wherein the power management unit includes:
a switch circuit for outputting an input voltage provided by a power supply to the power outlets to enable the power appliances; and
a detector circuit connected to the switch circuit and the power outlets for detecting status information of the power appliances;
wherein the detector circuit is configured to periodically detect the status information of the power appliances by a detection time.

17. The power distribution unit according to claim 16 wherein the switch circuit includes a relay, a MOSFET, a silicon-controller rectifier, a TRIAC, or an isolated gate bipolar transistor.

18. The power distribution unit according to claim 13 wherein when a response time is reached or the remote power management system requests the power distribution unit to transmit the status information, the first control unit compresses the status information into a status information compressed file and selectively transmit the status information compressed file and/or the status information to the remote power management system.

19. The power distribution unit according to claim 13 wherein the wireless communication unit is compliant with IEEE 802.11a-n protocol, Wi-Fi protocol, Bluetooth protocol, or ZigBee protocol.
